(19) United States
(12) Patent Application Publication
(10) Pub. No.: US 2008/0037214 A1
(43) Pub. Date: Feb. 14, 2008

(54) Computer chassis for two horizontally oriented motherboards

(75) Inventors: Eren Niazi, San Jose, CA (US); Marc Rotzow, San Jose, CA (US); Bryan Rodriguez, Snohomish, WA (US)

Correspondence Address: FENWICK & WEST LLP, SILICON VALLEY CENTER, 801 CALIFORNIA STREET, MOUNTAIN VIEW, CA, 94041, US

(73) Assignee: Open Source Systems, Inc., Sunnyvale, CA (US)

(21) Appl. No.: 11/502,891

(22) Filed: Aug. 11, 2006

(51) Int. Cl. G06F 1/20

(52) U.S. Cl. 361/687

(57) ABSTRACT

One embodiment is a computer chassis for housing modules of a computer system. According to this embodiment, the chassis features a chassis base, first and second bays for first and second motherboards, a fan assembly for mounting fans, a backplane for I/O connections mounted to the chassis base, and at least two compartments for electronic components. The first bay and the second bay are laterally adjacent so that, when in use, the first and second motherboards are in substantially the same plane. The fan assembly is mounted to the chassis base so that, when in use, fans in the fan assembly cause airflow in a substantially lateral direction over the first and second bays. The two compartments for electronic modules are laterally to the side of and in substantially the same plane as the first and second bays.

### BACKGROUND OF THE INVENTION

1. Field of the Invention

This invention relates generally to a chassis for a computer system and in particular to a chassis that can accommodate multiple servers and that has a tight form factor.

2. Description of the Related Art

A number of problems face those who use servers as part of a computer system. As processors continue to increase in speed, processing ability, and overall density in form factor, the need for increased power in turn increases heat production. This increased heat production increases the amount of cooling required to maintain ambient temperatures in which the processors can function properly. This poses problems for a data center or office having servers in that the cooling and power needs have increased over the years.

Because the price for power has also increased in most markets, data centers, in order to maintain profitability, require solutions that meet the power and cooling needs of customers without huge investments in infrastructure. An increase in cost can lead to loss of customers and/or to loss of profits.

Most data centers were designed and built several years ago when power and cooling needs were not as significant. It is likely that power needs will continue to scale with decreases in density, requiring increased cooling needs and increased power supplies. A few years ago the most powerful processors used about 65 watts. Modern processors require over 110 watts.

Data centers are rated on watts per square foot. This balances power and cooling over space. Because the building of data centers is an expensive project, costing in the range of tens of millions to hundreds of millions of dollars per location, there is a need for solutions (servers) that fulfill the needs of customers as well as the needs of the data center.

Manufacturers of servers need to satisfy the needs of the customer and the end location, e.g., a data center. Customers want high server performance, and data centers have power and cooling standards that need to be maintained. Customers also are concerned about the space taken up by servers because customers usually pay data centers in part based on space taken up in the data center. For the data center, the greater the density of the server cluster, the more power and cooling per square foot that must be provided. Therefore, a need exists for a server design that is compact and reduces power consumption.

### SUMMARY OF THE INVENTION

In general, in one aspect, the invention features a computer chassis for housing modules of a computer system. According to this embodiment, the chassis features a chassis base, first and second bays for first and second motherboards, a fan assembly for mounting fans, a backplane for I/O connections mounted to the chassis base, and at least two compartments for electronic components. The first and second bays are laterally adjacent so that, when in use, the first and second motherboards are in substantially the same plane. The fan assembly is mounted to the chassis base so that, when in use, fans in the fan assembly cause airflow in a substantially lateral direction over the first and second bays. The two compartments for electronic modules are laterally to the side of and in substantially the same plane as the first and second bays.

According to another aspect, the invention features a computer system. In this embodiment, the computer system features a chassis base, a first motherboard and a second motherboard mounted to the chassis base, a fan assembly including at least one fan, a backplane for I/O connections coupled to a rear end of the chassis base, and at least two hard drives mounted to the chassis base. In this embodiment, the first motherboard and the second motherboard are in substantially the same plane, and the at least two hard drives are laterally to the side of and in substantially the same plane as the first and second motherboards. The fan assembly is mounted to the chassis base at a front end so that, when in use, the fan causes airflow in a substantially lateral direction over the first and second motherboards. Thus, in this embodiment, heat exists the computer system from the rear through the backplane.

These embodiments of the invention can allow two independent systems to be configured in a single chassis having a standard height of one unit, where a “unit” is a standard measure of height of a server in a standard server rack or cabinet. This provides for improved density for a chassis to be mounted in the server rack or cabinet. In addition, the fan assembly causes air flow and heat exhaustion from the rear of the chassis. This design provides advantages for some data centers that organize cabinets of servers with “hot” and “cold” aisles, with heat being exhausted to the hot aisles. With the exception of the chassis and its component pieces, all parts used to form a computer system using the chassis can be standard components that may be purchased from a variety of suppliers.

### BRIEF DESCRIPTION OF THE DRAWINGS

FIG. 1A is a front perspective view of a computer chassis in accordance with embodiments of the invention;

FIG. 1B is a front perspective view of a computer chassis with components in accordance with embodiments of the invention;

FIG. 2 is a top view of the computer chassis of FIGS. 1A and 1B and more particularly of the lid of the computer chassis of FIGS. 1A and 1B;

FIG. 3 is a side view of the computer chassis in accordance with the embodiment of FIGS. 1A and 1B;

FIG. 4 is a front perspective view of a fan assembly in accordance with the embodiment of the invention of FIGS. 1A and 1B;

FIG. 5 is a front view of the fan assembly of the embodiment of FIG. 4;

FIG. 6 is a top view of the fan assembly of the embodiment of FIG. 4;

FIG. 7 is a front perspective view of the IO backplane of the chassis of FIGS. 1A and 1B;

FIG. 8 is a front view of the IO backplane of the embodiment of FIG. 7;

FIG. 9 is a top view of the 10 backplane of the embodiment of FIG. 7; and

FIG. 10 is a front perspective view of a rack showing the use of the chassis of one embodiment of the invention.

### DETAILED DESCRIPTION

One embodiment of the invention is a chassis for a computer system that can be used with a variety of standard components. According to this embodiment, more than one computer server can be assembled in a lateral orientation in a highly available system using a 1 U form factor. The chassis can include a fan assembly that causes airflow over each of the servers to maintain proper cooling. Such an embodiment can improve overall reliability of a server farm, allowing increased density and simplification of cooling issues that are often associated with large numbers of servers. The tight form factor of the chassis also increases the total number of servers that can be installed in a particular server rack. This embodiment can lower overall power consumption, allow for a large variety of configurations for the end consumer, and simplify serviceability. In some embodiments, the chassis is designed to be easily mounted in a standard server rack. Another embodiment of the invention is a computer system using the chassis described above along with standard electronic components.

To increase density and availability, in one embodiment, the chassis supports two individual motherboards in 1 unit of height. This allows for dual density in the number of computers within the body of the same chassis. Through the use of open source clustering software, the two servers can be operated as one unit, or they may continue to operate as independent servers within the same chassis.

Server Racks

Servers are typically stored in racks or cabinets in a data center. A server rack can be a standard 19-inch rack (Electronic Industries Alliance 310-D, International Electrotechnical Commission 60297 and Deutsches Institut für Normung 41494 SC48D) system for mounting various electronic modules in a “stack”, or rack, 19 inches (482.6 mm) wide. Equipment designed to be placed in a rack is typically described as rack-mount, a rack mounted system, a rack mount chassis, sub-rack, or sometimes, simply a shelf.

The rack's mounting fixture usually includes two parallel metal strips (also referred to as “rails”) standing vertically. Typically, the strips are each 0.625 inches (15.875 mm) wide and are separated by a gap of 17.75 inches (450.85 mm), giving an overall rack width of 19 inches (482.6 mm). The strips have holes in them at regular intervals, with both strips matching, so that each hole is part of a horizontal pair with a center-to-center distance of 18.3 inches (464.82 mm).

The holes in the strips are arranged vertically in repeating sets of three, with center-to-center separations of 0.5 inch (12.7 mm), 0.625 inch (15.875 mm), and 0.625 inch (15.875 mm). The hole pattern thus repeats every 1.75 inches (44.45 mm). Racks are divided into regions, 1.75 inches in height, within which there are three complete hole pairs in a vertically symmetric pattern. The holes are centered 0.25 inch (6.35 mm), 0.875 inch (22.225 mm), and 1.5 inches (38.1 mm) from the top or bottom of the region. Such a region is commonly known as a “unit” or a “U,” and heights within racks are measured by such a unit. Rack-mountable equipment is designed to occupy some integral number of U. For example, rack-mountable computers are most often 1 U or 2 U in height. Thus, it is desirable to design chassis for computer systems that can engage with standard racks.

A typical cabinet usually conforms to these internal standards as well. Instead of a two-post structure, they usually have a four-post structure. In this case, servers are mounted on four-post rails that typically allow the machine to slide in and out of the cabinet. The typical depth is approximately 30 inches for servers with a small amount of additional space for airflow, door space, as well for as any cables, such as for a monitor, or serial or power cables. The cabinet can contain side panels that help to conceal and channel cabling as well as structure airflow. The cabinet can also have doors that may or may not contain a locking mechanism. These doors can have a glass front or perforated front. It is preferable to utilize a perforated cabinet, which allows for better airflow and cooling.

Cabinets are typically placed in rows within a data center and arranged in formations that facilitate cooling by designating one aisle for cooling facing the front of the machines and a second aisle for exhausting heat, i.e., a “hot aisle.” While a typical cabinet contains 42 Rack Units of space (in height) internally, it does not always allow for placement of 42 1 U servers because networking equipment, or other equipment such as a serial console aggregator box or monitor, may be mounted in the cabinet. Density of servers in the cabinet can be limited based on cooling and power arrangements within the data center.

Chassis

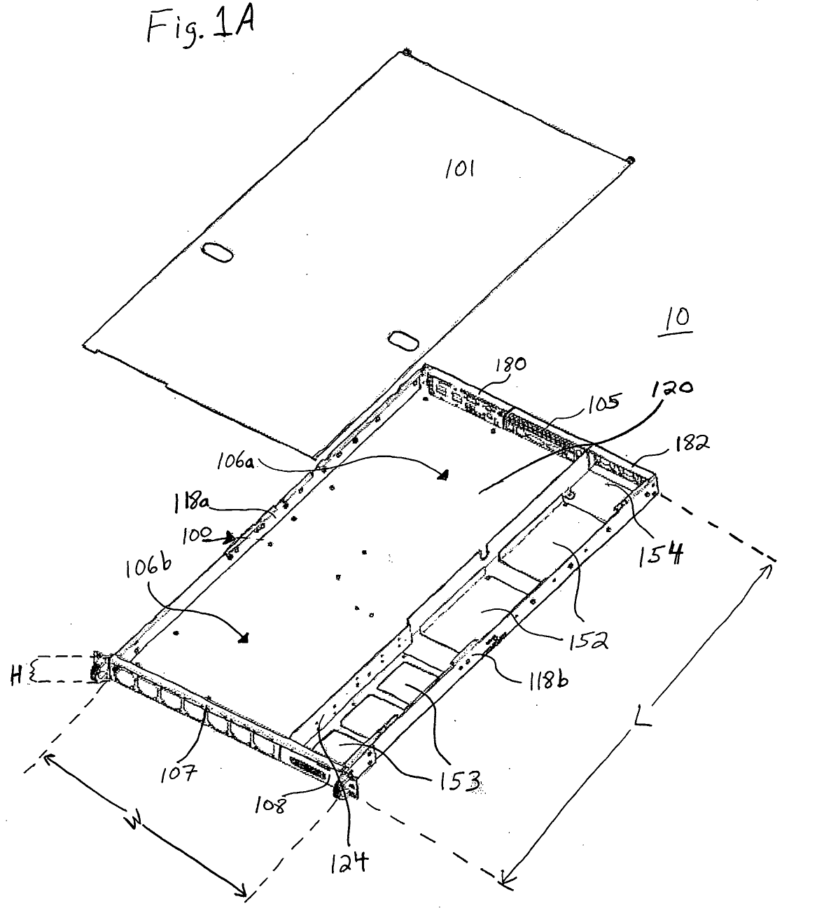

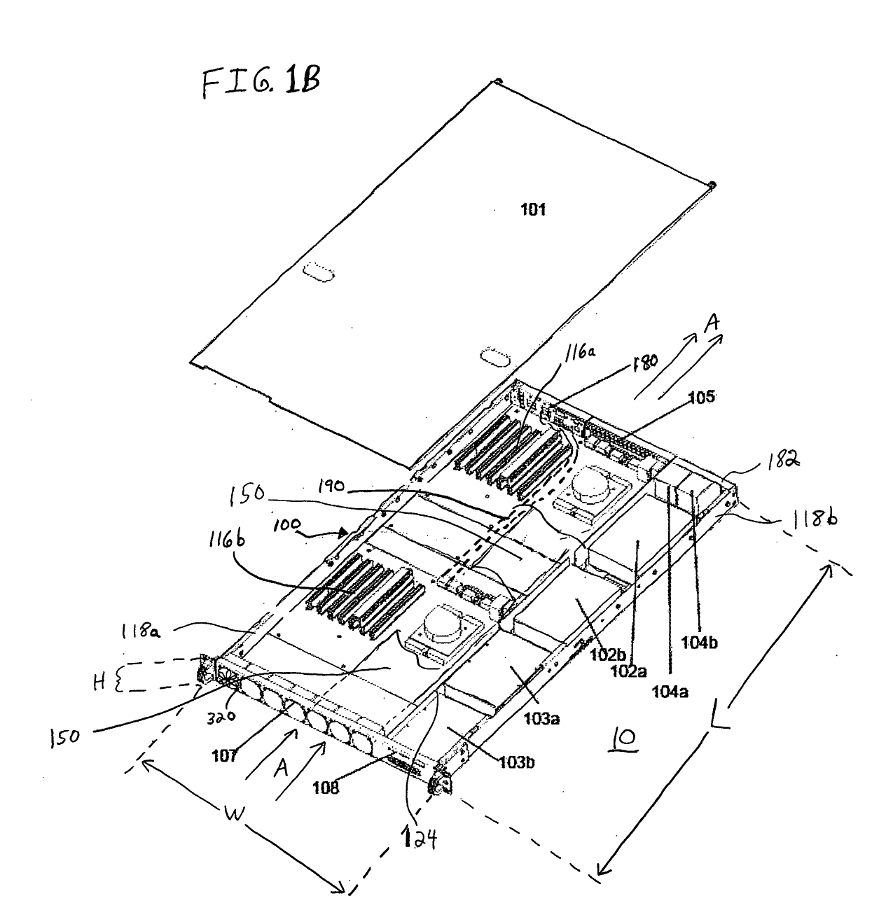

FIG. 1A is a front perspective view of a computer chassis 10 in accordance with embodiments of the invention. FIG. 1B is a front perspective view of the same computer chassis 10 having components included therein. In this embodiment, the chassis 10 includes a chassis base 100, at least two bays 106a, 106b (FIG. 1A) for motherboards 116a, 116b (shown in FIG. 1B) of the computer system, and a plurality of compartments 152, 153, 154 (FIG. 1A) for electronic modules, such as hard drives 103a, 103b, power supplies 102a, 102b, and electrical connectors 104a, 104b (FIG. 1B). The chassis 10 can include a fan assembly 107 at a front end of the chassis 10. At the rear end, the chassis 10 can include an IO backplane 105. The chassis 10 can also include a top or lid 101. When assembled, these components form a chassis 10 for a computer system. The components of the chassis 10 can be made from a variety of materials, including, for example, metals and plastics.

The chassis base 100 includes a bottom wall 120 and two sidewalls 118a, 118b. In the embodiment of FIGS. 1A and 1B, the bottom wall 120 is rectangular in shape, as are the two sidewalls 118a, 118b. The two sidewalls 118a, 118b are assembled at approximately 90 degree angles to the bottom wall 120. Thus, in this embodiment, the chassis 10 is rectangular in shape when assembled.

In the embodiment of FIGS. 1A and 1B, the overall dimensions of the chassis 10 are about 30 inches in length L, 18.5 inches in width W, and 1 U in height H. In other embodiments, these dimensions can vary.

The embodiment of FIG. 1B shows the chassis 10 with two motherboards 116a, 116b in the bays 106a, 106b, respectively. The bays 106a, 106b (FIG. 1A) are oriented in the chassis base 100 laterally to each other. Thus, the two motherboards 116a, 116b and bays 106a, 106b are laterally adjacent each other so that both motherboards 116a, 116b are in substantially the same plane. The two motherboards 116a, 116b need not touch each other or be immediately adjacent each other, but can instead be separated by additional structures within the chassis 10. In the embodiment of FIG. 1B, the two motherboards 116a, 116b are mounted in the chassis 10 in a 1 U form. This allows the chassis 10 to be installed in a server rack in a height of 1 unit. In other embodiments, more than two motherboards can be installed in the chassis 10.

The motherboards 116a, 116b can be any type of motherboard, such as a server. For example, the bays 106a, 106b can be generally rectangular in shape and can be formed by a space defined by the bottom wall 120, the lid 101, at least one of the sidewalls 118a, and a sidewall structure 124. The bays 106a, 106b can be sized to accommodate common servers. The bays 106a, 106b can be designed to handle a number of server motherboards from a variety of manufacturers, such as, but not limited to Tyan, Supermicro, Asus, and Intel. The bays 106a, 106b can handle single or dual socket motherboards and up to one PCI card each. In addition, the motherboards 116a, 116b can be fastened to the chassis base 100 with screws or thumbscrews. The two motherboards 116a, 116b can be the same type or can be different types of motherboards.

In the embodiment of FIG. 1B, each motherboard 116a, 116b has a separate power supply, as indicated by for power supplies 102a, 102b. FIG. 1B uses the numerals 102a, 102b to denote the power supply modules, which fit within compartments 152 of FIG. 1A during use. The power supplies 102a, 102b can connect to the rear of the chassis 10, and in particular to two power plug connectors 104a and 104b. Power plug connectors 104a, 104b fit within compartment 154 of FIG. 1A. In this embodiment, the power supplies 102a, 102b, power plug connectors 104a, 104b, and motherboards 116a, 116b can reside in substantially the same plane so that the chassis 10, when assembled, has a height of approximately 1 U. In other embodiments, the height of the chassis 10 can vary.

The chassis 10 of FIG. 1A also includes compartments 153 for additional electronic modules, such as hard drives. FIG. 1B shows an embodiment with electronic modules 103a, 103b within compartments 153 of FIG. 1A. As with compartments 152 and 154, compartments 153 can reside in substantially the same plane as the motherboard bays 106a, 106b, thus maintaining the 1 U height of the chassis. In some embodiments, the electronic modules 103a, 103b can be hard drives. For example, one of the hard drives can be for motherboard 116a, the other hard drive can be for motherboard 116b, or both hard drives can be used by the same motherboard (either motherboard 116a or 116b). Any type of drive can be used in the chassis 10, such as, but not limited to Serial ATA, i.e., SATA, SCSI, Fiber Channel, or Serial Attached SCSI, i.e., SAS. In some embodiments, the hard drives are all located in the side of the chassis 10 and have interchangeable backplanes (not shown) that are attached to the chassis 10 via thumbscrews to accommodate different types of hard drives. Such embodiments allow one drive per motherboard and do not require that the drives match. That is, each server could have a different type of hard drive.

In one embodiment according to FIGS. 1A and 1B, all components mounted within the chassis 10 can be standard components capable of being purchased from a large number of manufacturers. For example, the motherboards 116a, 116b, hard drives or electronic modules 103a, 103b within compartments 153, the power supplies 102a, 102b, and the power plug connectors 104a, 104b can be standard components that can be readily purchased from a number of manufacturers. In this embodiment, only the chassis 10 itself is a custom design. Components such as the cable extenders 190 (FIG. 1B) that will carry the IO connectors of motherboard 116b can also be standard components. The overall cost of the individual server can be lowered through the use of standardized components compared to the use of customized components. The benefits of using customized components generally do not outweigh the costs compared to the use of standard components. Manufacturers create custom components in smaller numbers and frequently require a single vendor, which limits supply of the components. Standard components can be purchased from a variety of suppliers. This enables the manufacturer to compare the same component across multiple vendors and to lower the cost of the server manufacturing process.

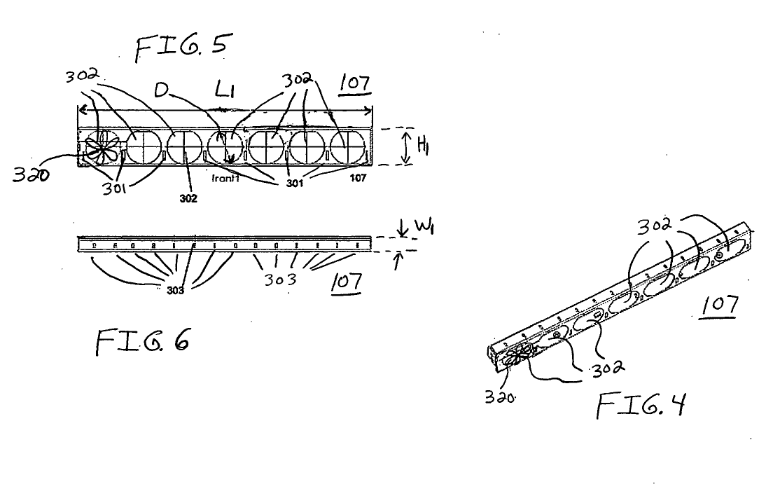

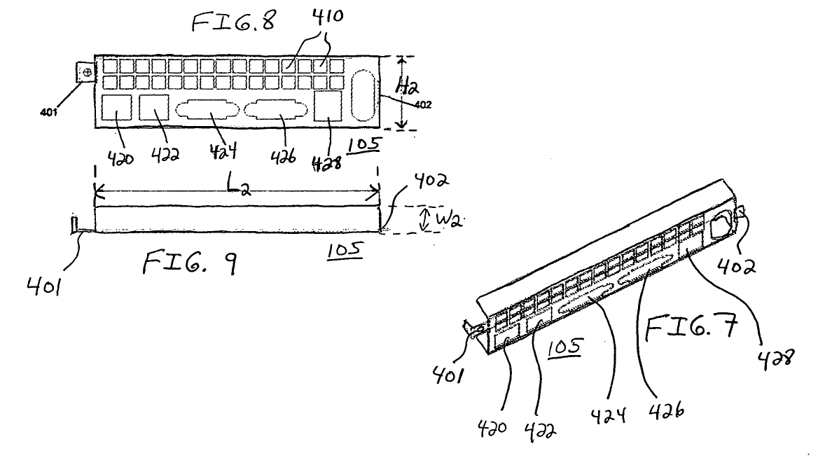

The embodiment of FIGS. 1A and 1B includes a fan assembly 107, which is described in greater detail below in connection with FIGS. 4-6. The chassis 10 also includes IO shield backplane 105, which is described in greater detail below in connection with FIGS. 7-9. In the chassis 10 of FIGS. 1A and 1B, the fan assembly 107 sucks in air for cooling, which is ultimately exhausted from the rear of the chassis 10, in essence through the IO shield backplane 105.

The rear of the chassis 10 is generally formed from the combination of IO backplane 105, back wall portion 182, and attached backplane 180. The IO backplane 105 can include connectors for a number of items from the IO portion of the motherboard 116a. The IO backplane 105, in this embodiment, is a removable structure that can be used for connections to motherboard 116a. Motherboard 116a can be directly connected to IO backplane 105 so that IO ports of motherboard 116a can be accessed from the rear of the chassis 10. Backplane 180 can be more permanently attached to the chassis base 100 and can be used for IO connections for motherboard 116b. Thus, connector cables 190 or the like can be used to connect motherboard 116b to the IO ports of backplane 180. Back wall portion 182 makes up the remaining portion of the rear of the chassis 10, and back wall portion 182 can be attached to IO backplane 105 for this purpose. Thus, the combination of IO backplane 105, back wall portion 182, and attached backplane 180 forms the rear of the chassis 10 having a width W of about 18.5 inches.

FIGS. 1A and 1B show an embodiment in which a front panel 108 of the chassis 10 includes an area in which indicator lights for connectivity and status of the servers can be displayed. This front panel 108 can contain indicators/buttons such as power indicator lights, hard drive activity lights, and reset buttons.

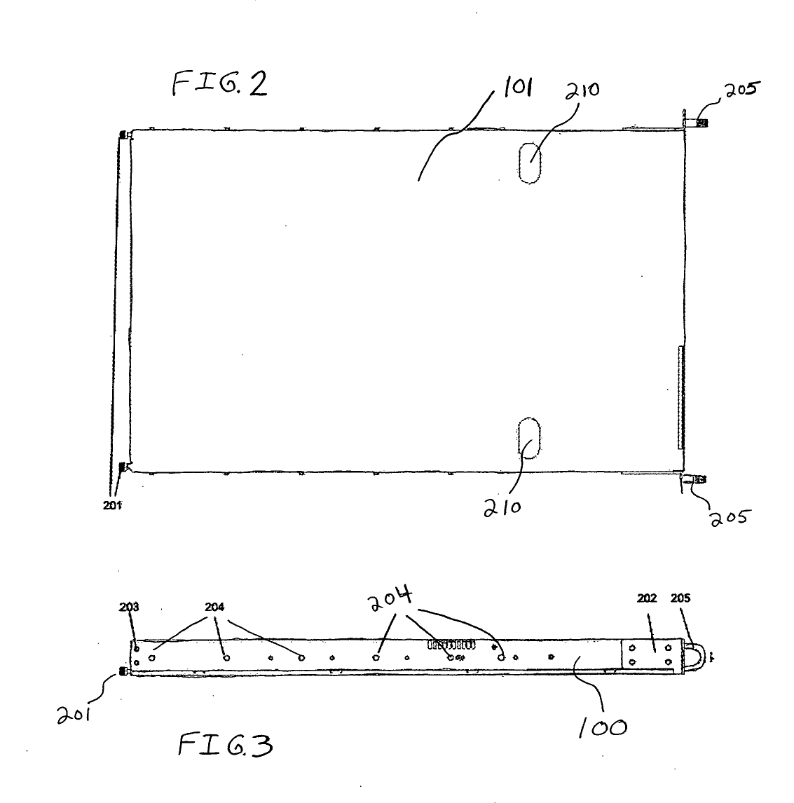

FIG. 2 is a top view of the computer chassis 10 of FIGS. 1A and 1B and more particularly of the lid 101 of the computer chassis 10. The front of the lid 101 is on the right of FIG. 2, this corresponds to the front/left of FIGS. 1A and 1B. The chassis 10 and lid 101 are generally rectangular in shape in this embodiment, although the shape can vary within the scope of the invention. The lid 101 of the chassis 10 can form an enclosed structure without the use of numerous screws for opening and closing the lid 101. As shown in FIG. 2, the chassis base 100 and lid 101 are slip-fitted to one another and secured with thumbscrews 201. The lid 101 can also contain two openings 210 for cooling purposes.

FIG. 3 is a side view of the computer chassis 10, and more particularly of the chassis base 100. FIG. 3 shows front mounting ears 202 for attachment of the chassis 10 to a server rack (not shown). Alternatively or in addition to the front mounting ears 202, rear mounting ears 203 can be used for attachment to a server rack. However, the chassis 10 can also be mounted in a server rack or cabinet by front mounting ears, center mounting ears, rear mounting ears, or a combination of these types. For example, a typical combination includes the use of front and rear mounting ears, as shown in FIG. 3. The chassis 10 can also be mounted to a four post cabinet or rack via sliding rails. Sliding rails would be attached to the side of the chassis 10 via screws in the screw mount holes indicated on the side of the chassis 10, including, for example, holes 204. Additionally, a set of handles 205 on the front of the chassis 10 allows for easy removal of a server from a cabinet. The handles 205 can be rigidly attached to the sidewalls 118a, 118b.

FIGS. 4 through 6 are isolated views of the front fan assembly 107 of the chassis 10 of FIGS. 1A and 1B. In particular, FIG. 4 is a front perspective view of such a fan assembly 107, FIG. 5 is a front view, and FIG. 6 is a top view. A series of fans can be attached anywhere within the chassis 10. In one embodiment, one or more fans can be attached to the chassis 10 using bracket holes on the fan assembly 107. Fans can be attached to the fan assembly 107 via brackets 301 and 303. FIG. 5 shows a plurality of brackets 301 on the front side of the fan assembly 107, and FIG. 6 shows a plurality of brackets 303 on the top of the fan assembly 107. When assembled, the fans fit within the openings 302 of the fan assembly 107. FIGS. 4-6 show an embodiment with openings 302 for seven fans. In a typical embodiment, fans are affixed in each of these openings 302. In other embodiments, however, not all of these openings 302 for fans are used. For example, FIGS. 4 and 5 show only a single fan 320 in the fan assembly 107. Instead, the proper number of fans to provide the cooling required by the motherboards in the chassis 10 are used.

In the embodiment of FIGS. 4-6, the openings 302 are sized to fit fans of standard sizes. In one embodiment, the fan assembly has a length L1 of approximately 12.2 inches, a width W1 of approximately 1.7 inches, and a height H1 of approximately 1 U. This embodiment of the fan assembly 107 has a generally rectangular shape. In this embodiment, each fan opening 302 has a circular shape with a diameter D of approximately 1.45 inches. In one embodiment, a fan to be used in one of the openings 302 can have a blade that is about 0.55 inches wide. Such a fan can be attached with screws into the fan assembly 107. In use, after affixing fans to the fan assembly 107, the fan assembly 107 is attached to the chassis base 100. In one embodiment, the fan assembly 107 can be affixed to the bottom wall 120 of the chassis 10 and to sidewall 118a through screws or bolts. The fan assembly 107 and front panel 108 together can form the front of the chassis 10.

In operation, the fan assembly 107 is designed to pull air from a cold aisle in a standard data center across the two motherboards 116a, 116b in the chassis 10. Referring to FIGS. 1A and 1B, the fans in the fan assembly 107 move cool air in from the front of the chassis 10, over the motherboards 116a, 116b, and then out from the chassis 10 at the rear. That is, the general air flow through the chassis 10 is in the direction of the arrows A in FIG. 1B.

The chassis 10 can provide advantages in cooling, which can be an important issue for servers and data centers. In the embodiment of FIGS. 1A and 1B, heat from the components is transferred to the back of the server to be exhausted from the rear. The two servers in the single chassis 10 can use less power for cooling than would be required if each server had a separate chassis. For example, separate fans would be required for each individual server if each server had its own chassis; combining two servers in a single chassis can decrease the power required for cooling. Fans can be placed nearly anywhere in line in the chassis 10, and more or fewer fans can be added depending upon the cooling needs of the server or servers.

The chassis 10 can also include ducting internally for more focused heat dissolution. For example, the chassis 10 of FIG. 1B contains ducting 150 to direct airflow from some of the fans (three fans in this embodiment) in the fan assembly 107 over motherboards 116b, 116a. The ducting 150 shown in FIG. 1B is partially cut away in order to show other components within the chassis 10. The ducting 150 can run parallel to the chassis's length, focusing airflow where needed for cooling. In some embodiments, all of the openings 302 of the fan assembly 107 can have ducting associated therewith, while in other embodiments, only some of the openings 302 can have associated ducting. In still other embodiments, a combination of fans can use one set of ducting, while the other fans can use other sets of ducting. The fan assembly 107 and orientation of the chassis 10 of the present invention allow for cooler temperatures with fewer fans than two individual chassis systems, each having its own set of fans.

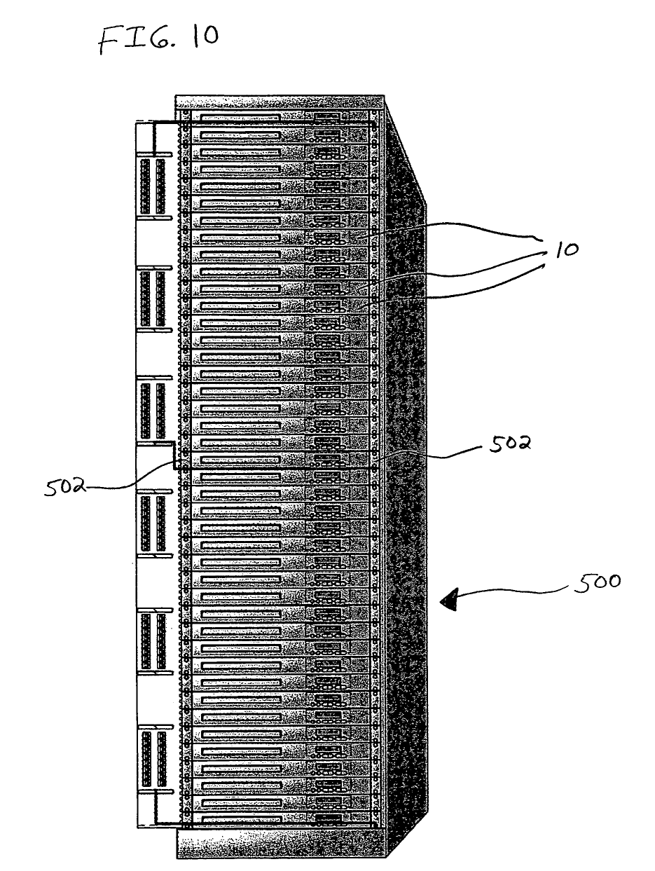

FIGS. 7 through 9 are isolated views of the IO backplane 105 of the chassis 10 of FIGS. 1A and 1B. In particular, FIG. 7 is a front perspective view of such an IO backplane, FIG. 8 is a front view, and FIG. 9 is a top view. The backplane 105 includes a variety of connectors for the motherboard 116a. Thus, the IO backplane 105 has connections for a series of items from the IO portion of the motherboard 116a.

In use, the IO backplane 105 can be attached to chassis base 100 via a screw plate 401. The screw plate 401 can be on one or both sides of the backplane 105 (it is on only one side in FIGS. 7-9), and it contains at least one hole that can mate with a hole on the backplane 180 or back wall structure 182 for attachment. The backplane 105 can then be fitted and snapped into place using tab 402. In the embodiment of FIGS. 7-9, the tab 402 is on the opposite side of the backplane 105 from the screw plate 401. The openings 420, 422, 424, 426, 428 in the backplane 105 can mate with ports of the motherboard 116a in order to form IO connections for the server.

The backplane 105 can have varying dimensions. In the embodiment of FIGS. 1 and 7-9, the backplane has a length L₂ of about 5.91 inches, a width W₂ of approximately 0.4 inches, and a height H₂ of about 1 U. In other embodiments, these dimensions can vary. The IO backplane 105 also has a plurality of hulls 410 or openings to allow for airflow through the backplane 105, and hence out of the chassis 10. In operation, backplane 105 can be placed side-by-side lengthwise with backplane 180, and combined with another plate 182 to form the rear of the chassis 10.

The backplane 180 can, in some embodiments, be substantially the same as backplane 105. For instance, backplane 180 can have the same dimensions and shape. In one embodiment, backplane 180 is permanently or semi-permanently attached to the chassis 10, whereas, in this embodiment, backplane 105 can be readily attached and removed from the chassis 10. The backplane 180 can be used for IO connections for motherboard 116b at the front of the chassis 10. Standard cable extenders can be utilized to connect the keyboard, video, and mouse (KVM) ports, as well as all other ports, of the motherboard 116b that is furthest from the rear of the chassis 10.

FIG. 10 is a front perspective view of a rack or cabinet 500 that can house a number of the chassis 10 of the invention. FIG. 10 shows a series of chassis 10 in a standard rack 500 to demonstrate the concept of density. FIG. 10 specifically calls out a number of the chassis 10 within the rack 500. In this embodiment, each chassis 10 is mounted on a series of rails 502 of the server rack. Each individual chassis 10 can be mounted in the cabinet in a space having a height of 1 U. If the rack 500 is a standard rack and if it were fully populated, the rack 500 would contain 84 servers. That is, the chassis 10 holds two servers per 1 unit of height, and a standard cabinet is 42 rack units in height.

The chassis 10 of the invention can provide several advantages. The chassis 10 can allow for density and redundancy that is important for the growth of many online businesses. For example, by allowing two motherboards to be assembled in a single 1 U chassis, the chassis of the invention can increase density of servers in cabinets. In addition, by providing for two servers within one chassis, redundancy can be built into a server system. For example, one of the motherboards can act as a backup for the other motherboard if there is a failure.

Internal redundancy and/or density increases can increase server availability. While a server farm may be negatively impacted by the removal of a single unit, one may limit the need for this through the use of internally redundant parts, whether it is redundant fans, power supplies, hard drives, the use of RAID, i.e. a redundant array of inexpensive devices. The chassis 10 of the invention, which has two motherboards in a single chassis 10, can easily be configured to provide for redundancy.

High availability can also be addressed on a software level through the use of virtualization services or load balancing. Load balancing is the employment of a device that virtualizes an IP address and sends network traffic to a series of servers that sit behind it. Network traffic is distributed based upon a predefined set of variables. In short, the load is shared amongst the servers so that the loss of one server merely forces the others to do an appropriate additional percentage of work. Virtualization services include clustering software that modifies the role of individual servers so that an individual or group of machines would appear as a single machine. This is often implemented to perform functions of parallel computing, wherein a variety of servers perform a single task. An individual physical server can also contain a series of virtual servers to perform parallel tasks within the node. While this action does not typically provide redundancy, it does utilize unused internal resources on a physical server.

The chassis 10 of the invention can also improve the overall availability of computers conforming to known standards for data centers. For example, the chassis 10 can utilize standard components, such as motherboards, hard drives, and power supplies. In addition, the chassis 10 is sized to take up 1 U of space within a standard cabinet.

In addition, the server cost can decrease because numerous parts do not need to be duplicated for separate servers in separate chassis. That is, numerous parts in the chassis 10 can be used by two servers, so these parts do not need to be reproduced. This also produces some cost savings in that only one chassis needs to be purchased for two servers. Both servers in a single chassis 10 can be accessed through the rear of the chassis 10 in the “hot aisle.” Allowing both servers to be accessed from the rear uses the design matrix employed by most data centers, which designate intermittent rows as “hot” and “cold” rows. “Hot aisles” are aisles into which heat is exhausted, and “cold aisles” bring in cooler air for cooling purposes. While some “density” driven chassis designs do exist, they fail to account for the standard practice in the design of data centers for heat removal. Many designs exhaust heat from the top or in other ways not generally practiced at most data centers.

There are a number of commercially available chassis backplanes to be affixed to the back of the chassis 10 of the invention. These backplanes are designed as individual components that may be mixed and matched, allowing for greater versatility in the chassis design. Because there are two servers in a single 1 U height space, a second backplane panel can be utilized in order to accommodate the server network. Standard cable extenders can be utilized to connect the keyboard, video, and mouse (KVM) ports of the motherboard that is furthest from the rear (motherboard 116b in FIG. 1B). In the case of USB, network, and other connectors, a standard component module can be employed to connect these connectors to the motherboard that is furthest from the rear. Many commercially available servers have a fixed type of backplane for connection to only certain types of components. The chassis 10 of the invention can use a variety of types of backplanes 105 so that different types or brands of components can be used in the chassis 10. Backplane 105 can be readily removed and replaced with another backplane with proper porting holes for a different motherboard 116a.

The dimensions described above are exemplary, and these dimensions can vary within the scope of the invention. In addition, the advantages of the present invention set forth above are exemplary only, and not all of these advantages need to be present to be within the scope of the invention. In addition, there may be numerous advantages provided by the chassis 10 of the present invention that may not be set forth above. While the present invention has been described with reference to several embodiments thereof, those skilled in the art will recognize various changes that may be made without departing from the spirit and scope of the claimed invention. Accordingly, the invention is not limited to what is shown in the drawings and described in the specification, but only as indicated in the appended claims. Thus, other embodiments are within the scope of the following claims. Thus, other embodiments are within the scope of the following claims.

What is claimed is:

1. A computer chassis comprising:
a chassis base;
a first bay for a first motherboard and a second bay for a second motherboard in the chassis base, wherein the first bay and the second bay are laterally adjacent so that, when in use, the first motherboard and the second motherboard are in substantially the same plane;
a fan assembly for mounting fans, wherein the fan assembly is mounted to the chassis base so that, when in use, fans in the fan assembly cause airflow in a substantially lateral direction over the first and second bays;
a backplane for I/O connections coupled to one end of the chassis base; and
at least two compartments for electronic modules, wherein the at least two compartments are laterally to the side of and in substantially the same plane as the first and second bays.

2. The chassis of claim 1, wherein the chassis has a height of one standard unit.

3. The chassis of claim 1, wherein the at least two compartments are for hard drives.

4. The chassis of claim 3, wherein the chassis includes two hard drives, each mounted in one of the two compartments.

5. The chassis of claim 1, wherein the at least two compartments are for power supplies.

6. The chassis of claim 1, wherein network connections for the first and second motherboards are connected to the backplane in the rear of the chassis.

7. The chassis of claim 1, wherein the fan assembly includes spacing for placement of more than one fan across a row.

8. The chassis of claim 1, wherein ducting exhausts heat from the two motherboards out of the rear of the server.

9. The chassis of claim 1, wherein each motherboard includes I/O connectors including keyboard, video, mouse, USB and network ports.

10. The chassis of claim 1, wherein network connections from the motherboards are connected to the backplane.

11. The chassis of claim 1, further comprising at least one fan connected to the fan assembly.

12. The chassis of claim 11, wherein heat is exhausted out of the rear of the chassis.

13. The chassis of claim 1, wherein the chassis is connected to a rack via a system of rails, wherein the chassis has a height of one standard unit of the rack.

14. A computer chassis for use in a rack having a railing system to divide the rack into compartments having a standard unit of height, the chassis comprising:
a chassis base having a height of one standard unit;
a first bay for a first motherboard and a second bay for a second motherboard in the chassis base, wherein the first bay and the second bay are in substantially the same plane so that, when in use, the first and second motherboards require only one standard unit of height;
a fan assembly for mounting fans, wherein the fan assembly is mounted to the chassis base at a front end so that, when in use, the fans in the fan assembly cause airflow in a substantially lateral direction over the first and second bays;
a backplane coupled to a rear end of the chassis base, the backplane for I/O connections of the first and second motherboards; and
at least two compartments for electronic modules, wherein the at least two compartments are laterally to the side of and in substantially the same plane as the first and second bays so that the height of the chassis is maintained at one standard unit.

15. The chassis of claim 14, wherein heat is exhausted out of the rear of the chassis.

16. The chassis of claim 14, wherein the fan assembly includes spacing for placement of more than one fan across a row.

17. The chassis of claim 14, wherein the at least two compartments are for hard drives.

18. The chassis of claim 17, wherein the chassis includes two hard drives, each mounted in one of the two compartments.

19. A computer system comprising:
a chassis base;
a first motherboard and a second motherboard mounted to the chassis base, wherein the first motherboard and the second motherboard are in substantially the same plane;
a fan assembly including at least one fan, wherein the fan assembly is mounted to the chassis base at a front end so that, when in use, the fan causes airflow in a substantially lateral direction over the first and second motherboards;
a backplane for I/O connections coupled to a rear end of the chassis base; and
at least two hard drives mounted to the chassis base, wherein the at least two hard drives are laterally to the side of and in substantially the same plane as the first and second motherboards.

20. The computer system of claim 19, wherein the computer system is connected to a rack via a system of rails, wherein the computer system has a height of one standard unit of the rack.
